(19) United States
(12) Patent Application Publication
(10) Pub. No.: US 2023/0119984 A1
(43) Pub. Date: Apr. 20, 2023

(54) System and Method for Development of an AI Computational Intelligence Platform for Energy Resilience in Buildings

(71) Applicant: Nana Wilberforce, Mars, PA (US)

(72) Inventor: Nana Wilberforce, Mars, PA (US)

(21) Appl. No.: 17/503,269

(22) Filed: Oct. 16, 2021

(51) Int. Cl. G05B 13/02; G06N 3/04

(52) U.S. Cl. CPC G05B 13/027; G06N 3/0445; G06N 3/0454; G06F 40/279

(57) ABSTRACT

Systems and methods are disclosed herein for completely automated system for energy management. The system uses advanced mathematical concepts and learning algorithms replacing all static rules-based software, to create an advance AI functionality including climate benefits of increased energy efficiency with lower greenhouse gas emissions and environmental benefits; reducing overall emission of other air pollutants, economic benefits including less investments in new power generation and transmission, stronger local economy; Utility infrastructure benefits include lowering of baseload and peak demand; Social benefits including increased disposable income providing the ability to spend on other needs, fewer public health stressors and direct benefits of the proposed integrated energy efficiency and resiliency solution include reduced building energy consumption, curtailing building peak load through energy efficiency measures for demand side management, allowing residents to shelter in buildings longer; reduction of energy spending; helping vulnerable populations avoiding dangerous and life-threatening situations due to weather and hazards.

### BACKGROUND

### Field of the Invention

Embodiments relate to the field of home energy management services and, in particular, to a system and procedure allowing it to communicate with sensors and its Al capabilities make it possible to dynamically, predictively, and holistically model the building systems and functions and detect anomalies and determine potential sub-optimal behavior to form a truly automated “energy efficiency” planning and implementation platform for buildings.

### Description of the Related Art

Just about all homes, employ energy consuming appliances and other devices. Although each appliance in a home usually is operated independently from one another, each draws energy from the home energy distribution system. During certain times of the day, such as morning or early evening, the draw on the energy provider energy distribution system is so great that the energy provider either brings on line additional power plants or buys additional power from other suppliers. This peak energy demand creates additional costs for the energy provider. The energy provider passed these additional costs onto each consumer.

The increased cost has several causes. The energy supplier must build, manage, supply and maintain facilities capable of producing and handling the maximum amount of power required during peak times. This includes additional production facilities that are idle during non-peak times and therefore decrease both the dollar and energy efficiency of the overall system. Furthermore, since some of these facilities need rapid startup to avoid brown out conditions, they may be of a type that is less efficient than other facilities even while operating at peak capacity.

Energy providers, appliance manufacturers, consumers, and the government each desire to reduce peak power demands and save energy and cost. For example, some energy providers provide cost savings incentives for consumers who volunteer not to run their appliances during peak energy demand. Most appliance manufacturers work towards producing more efficient appliances. Consumers may elect not to run their dishwasher, clothes washer, or clothes dryer in the morning or early evening. The government enacts laws to regulate the behavior of energy providers, appliance manufacturers, and consumers.

With the rapid advancements in technologies like smart grid, network communication, information infrastructures, bidirectional communication medium’s, energy conservation methodologies and diverse techniques, Home area networks (HANs) have undergone a revolutionary change pertaining to various areas of power consumption domains like electricity usage patterns, energy conservation at consumption premises, etc. Under a robust smart grid paradigm, modern home equipped with HEMS contributes significantly towards efficiency improvement, economizing energy usage, reliability, as well as conserving energy for distributed systems. There are multiple inventions that have been proposed in prior art regarding development of Computational Intelligence Platform for Energy Resilience in Buildings.

For instance, a U.S. Pat. 6,522,955B1 on system and method for power management is issued to Jeffrey A. Colborn. The patent is on a system and method for power management is described that provides for monitoring and controlling a regenerative fuel cell and at least one powered device. The power management system includes a communication interface to facilitate data transmission, a communication device for monitoring and controlling a regenerative fuel cell and at least one powered device, the communication device providing for sending data to and receiving data from at least one powered device over a communication interface, a regenerative fuel cell for providing storage and supply of electricity, and a power interface for allowing electricity generated by the regenerative fuel cell to power at least one powered device.

Another U.S. Pat. 6,633,823B2 on System and method for monitoring and controlling energy usage is issued to Nxegen Inc. The patent is on a system and method for real time monitoring and control of energy consumption at a number of facilities to allow aggregate control over the power consumption. A central location receives information over a communications network, such as a wireless network, from nodes placed at facilities. The nodes communicate with devices within the facility that monitor power consumption, and control electrical devices within the facility. The electrical devices may be activated or deactivated remotely by the central location. This provides the ability to load balance a power consumption grid and thereby proactively conserve power consumption as well as avoid expensive spikes in power consumption. The present invention also includes a wireless network for communicating with the number of facilities, and which allows other information to be collected and processed.

Another U.S. Pat. 7,177,728B2 on system and methods for maintaining power usage within a set allocation is issued to Jay Warren Gardner. The patent discusses an electric power management system includes a monitor for the total power usage of a facility that monitors a history of power consumption during a set time interval of a distribution system having at least one electric load. Predictions of available power are generated through out the time interval by comparing the history of power consumption to a set allocation. Available power predictions are transmitted to the at least one electric load. The at least one load control receives the power capability predictions and controls the energy usage of the at least one electric load such that the total energy usage of the facility does not exceed the set allocation.

A Chinese patent 1,024 98448B on home energy management system is issued to Chinese inventor. The patent discusses a home energy management system includes a database configured to store site report data received from a plurality of residential sites using a wireless home energy network at each site. Each residential site includes a thermostat accessible to the wireless home energy network. A processor is operably coupled to the database and configured to access the site report data and detect a current temperature set-point of the thermostat at a first residential site; detect a first seasonal profile of the thermostat; detect a current operating mode of a HVAC system operably coupled to the thermostat; and determine a thermostat schedule of the thermostat using the first seasonal profile and the current operating mode of the HVAC system.

Another patent on Intelligent power consumption information interactive management system is issued to Chinese inventor. The present invention provides an intelligent power management system of information exchange, including energy-saving devices and intelligent interactive terminals. The energy-saving device comprises a power saving switch, electric monitoring device, and a communication module; said energy saving switch, the electric monitoring device electrically connected to the communication module, the electric power consumption data monitoring device monitors the electrical equipment the communication module data to the electric interaction of the intelligent terminal, and receives the control instruction intelligent interaction terminal, transmitting said control command to said energy saving switch; the power saving switch according to the control instruction control device to switch between a power saving mode and a normal mode. The interactive terminal according to the intelligent power module of the communication data transmitted, the corresponding energy-saving device generates and transmits the control instruction. information exchange intelligent power management system of the present invention can provide comprehensive monitoring of electricity consumption of electrical equipment, to better guide the rational use of electricity users.

A U.S. Pat. on Energy management system and method bearing U.S. Pat. 9,3608,74B2 is issued to Samsung Electronics Co Ltd. The patent is on a method of managing at least one network device at a site includes providing a web-based control selector to manage a detection module to control the at least one network device at the site. The method includes enabling the detection module in response to an enabled setting of the web-based control selector, and initiating a change in an operating condition of the at least one network device at the site in response to the enabled detection module and based on a detected presence of a user at the site. The method proceeds by disabling the detection module in response to the disabled web-based control selector.

There are multiple inventions that have been proposed in prior art regarding energy management system. However, the utility of these systems has not been seen in advance form and for the above discussed needs. Moreover, most of the existing smart home and building energy management systems implement stagnant and non-predictive control techniques and therefore struggle to adapt to changing environment. Furthermore, they are unable to handle large quantities of heterogeneous data from multiple sensors and extract the system’s generalizable behavior and are therefore not effective as a predictive “energy efficiency” intelligence tool.

The current invention proposes a system which is the apparatus and method is based on unique feature of energy management system where the proposed system takes massive amounts of data to a central location and analyzes it. The data can be collected from multiple sources including but not limited to external weather, internal building temperature, electricity consumption, occupancy of building, equipments installed at building etc. Normally, this data resides in multiple different systems and is never connected together but in reality, each of these different sources directly impacts each other. The proposed system communicates with number of sensors and its AI capabilities make it possible to dynamically, predictively, and holistically model the building systems and functions by learning the underlying system interdependencies and generalizing overall system behavior. Further, the system’s AI capabilities allow it to detect anomalies and determine potential sub-optimal behavior. The system further communicates with actuation infrastructure and optimally controls equipment functions (e.g. HVAC).

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of an automated “energy efficiency” planning and implementation platform for buildings.

It is also the objective of the invention to provide an advance approach to facilitates the recording of energy consumption from multiple sources including but not limited to external weather, internal building temperature, electricity consumption, occupancy of building, equipment’s installed at building etc.

It is further the objective of invention to allow to communicate with number of sensors and its AI capabilities to make it possible to dynamically, predictively, and holistically model the building systems and functions by learning the underlying system interdependencies and generalizing overall system behavior.

It is moreover the objective of the invention to provide a detailed analysis and allow it to detect anomalies and determine potential sub-optimal behavior.

It is also the objective of the invention to allow to communicate with actuation infrastructure and optimally controls equipment functions (e.g. HVAC).

It is further the objective of the invention to provide the ability of buildings to predict and prepare for, withstand, recover rapidly from, and adapt to major or unanticipated disruptions. The system directly addresses this need by integrating AI enabled power outage prediction capabilities to proposed system.

It is also the objective of the invention to provide capabilities allowing to plan, control, and operate the critical building functions in a “resilient mode” during limited or no power states.

It is moreover the objective of the system to use AI techniques such as neural networks and reinforcement learning to predict occupancy status, detect user activity patterns and user profiling.

It is further the objective of the system to reduce stand-by consumption and thus saving the energy consumption.

It is further the objective of the invention to recommend adjustments that eliminate energy waste while keeping user comfortable.

It is additional objective of the invention to infer optimal configurations for environmental control systems (e.g. HVAC) and utilize occupancy status to actively modify the state of actuators.

It is also the objective of the invention to detect context like user presence and actions and furthermore predict context.

It is moreover the objective of the invention to provide a system which is intelligent and allows to learn and self-adapt to previously unseen scenarios such as modifications in the habits or preferences of users or to changes in climate.

It is moreover the objective of the invention to provide real time geolocation ecosystem where the network application or program can be installed on any of the network devices.

It is further the objective of the invention to identify inefficient energy usage in indoor temperature and lighting, allowing consumer to address the cause.

It is further the objective of the invention system presents intelligent algorithms that does not require user-driven off-line training or manual configuration thereby needing minimal deployment effort.

It is also the objective of the invention to inform user when equipment requires maintenance, an energy consumption audit, or replacement.

It is further the objective of the invention to provide a system which brings ease of use and convenience for the user.

It is also the objective of the invention to provide an efficient thermostat which beyond simple on/off, programmable features, can control connected devices to support budget’s comfort level.

It is moreover the objective of the invention to provide a system which is of a durable and reliable system developed from complex and advance algorithms.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a process view as per preferred embodiments of the invention.

### DETAILED DESCRIPTION

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses an advance system allowing using advanced mathematical concepts to create a functionality similar to that of the human brain. Leveraging the principles of Artificial Intelligence, it captures tens of thousands of data points using a few sensors that are strategically placed throughout the user’s home and provides environmental sensing, monitoring and feedback of energy consumption, reduction of stand by consumption, detect and predict context, learn user habits and preferences, analyze appliance energy consumption and plan energy saving actions.

Embodiments discuss an intelligent energy management system that uses state-of-the-art smart technologies (sensors, actuators, controllers etc.) and Artificial Intelligence (AI) capabilities for optimal energy management of buildings. The system monitors and controls HVAC, lighting, and other systems by integrating information obtained from sensors on a range of outdoor environmental (temperature, humidity), indoor environmental (temperature, humidity, carbon dioxide), and equipment sensors to reduce energy use.

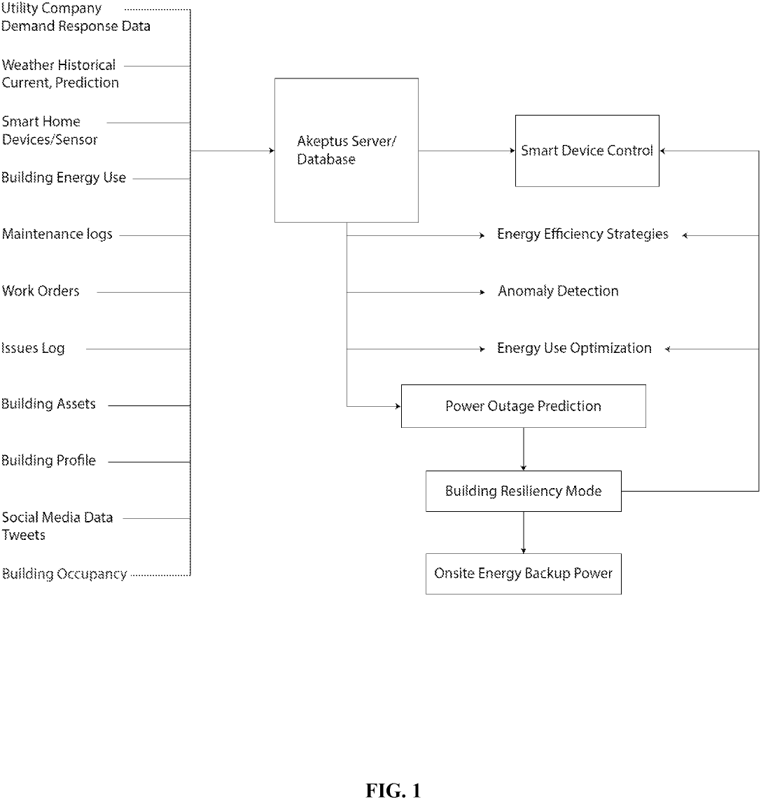

As per additional embodiments, the FIG. 1 is a process view as per preferred embodiments of the invention. The various components of the overall technology include a sensory infrastructure to track energy consumption and environmental data, an AI data analytics engine to process sensory data and develop energy efficiency strategies, an actuation infrastructure to control devices and execute energy strategies, and a user interaction framework to communicate with the consumer. The platform can intelligently monitor environmental conditions and take appropriate action to save energy while meeting user comfort. The system AI capabilities also enable it to adapt to user behavior and anticipate their needs while minimizing energy consumption.

The Machine Learning (ML) algorithms for real-time power outage prediction allow to plan and operate in resiliency mode during no or low power scenarios. The system proposes three ML modules including but not limited to AI model to predict number and location of power outages due to localized short duration storm events. An AI model to predict number and location of power outages due to extreme weather events like hurricanes and AI model that uses social media feeds and repair logs to improve and update number, location and also duration of power outages.

The initial outage prediction will be based on the environmental/weather data feeds and physical features available for a given geographical boundary. This initial prediction will be improved upon and updated in real time based on social media feeds (tweets) and live repair log entries. Multiple recurrent neural-network (RNN) models will be developed to provide a vector-space representation that can be easily integrated with physical features for predicting outage locations and outage duration.

The weather based initial outage prediction model as per its further embodiments will develop two models that will leverage weather forecasting feeds to predict localized storms and other severe weather events like hurricanes. The platform will combine weather forecasts and historical weather data with historical utility customer impact and/or infrastructure damage data to develop machine-learning predictive models for power outages in specific defined geographical boundaries well in advance of the event happening. The model will further allow to make an initial prediction of the number of future (using weather forecasts) power outages during a thunderstorm or severe weather event like a hurricane at a 2 km grid.

Furthermore, the social media based real-time outage prediction model allows precise location information which is crucial for accurate outage prediction. The ability to predict duration of unplanned power outages is critical for planning and operating building functions in a resilient mode during power outages. This will improve and update the initial outage prediction outputs from the weather-based prediction models(s) by combining it with real time social media feeds and real time repair log data. In particular, the system will leverage Natural Language Processing (NLP) to accurately classify true power outage related tweets and Geoparsing to accurately extract outage location from these true power (but not geotagged) tweets. We will also use NLP to automatically analyze text from incoming repair log field reports to predict duration of power outages in real-time.

The benefits of the proposed system is energy efficient and resilient buildings which address major issues such as high energy prices, energy security, air pollution, global climate change and others. They offer wide ranging benefits to the environment, economy, utility system, society and communities. The climate benefits of increased energy efficiency include lower greenhouse gas emissions and environmental benefits include reducing overall emission of other air pollutants. Economic benefits include less investments in new power generation and transmission, stronger local economy that is less susceptible to hazards and disruptions, an economy that is better positioned to manage energy price increases. Utility infrastructure benefits include lowering of baseload and peak demand. From a community perspective, resilient and energy efficient buildings reduce the level of risk a community faces due to natural hazards and improve its capacity to cope with those effects. This can be achieved by maintain energy supply during disruptions. Social benefits include increased disposable income providing the ability to spend on other needs (especially important for low-income families), fewer public health stressors.

Furthermore the direct benefits of the proposed integrated energy efficiency and resiliency solution includes reduced building energy consumption (optimal settings based on occupancy patterns; diagnosis and correction of faulty equipment operations and installation problems); curtail building peak load through energy efficiency measures for demand side management; allows residents to shelter in buildings longer; reduces energy spending; help vulnerable populations avoid dangerous and life-threatening situations due to weather and hazards; optimizes backup power.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1:. An apparatus for facilitating a home energy management where managing a plurality of energy consuming devices associated to an individual consumer and connected on a power distribution system to an energy supplying system and real-time power outage prediction that will provide needed information to proposed system to plan and operate in resiliency mode during no or low power scenarios comprising of following scenarios:
an AI model to predict number and location of power outages due to localized short duration storm events;
an AI model to predict number and location of power outages due to extreme weather events like hurricanes; and,
an AI model that uses social media feeds and repair logs to improve and update number, location and also duration of power outages.

2:. An integrated Resiliency-Energy Efficiency platform comprising:
AI Processing Engine to target the energy consumption of appliances, learning user preferences, recognizing current activities, automated implementation of energy efficiency plans;
Sensory Infrastructure allowing to measure energy consumption; Sensors for acquiring environmental data (e.g., temperature, humidity) and context information (user presence); and,
Actuation Infrastructure to control HVAC, lighting, appliances and other devices.
